(19) United States
(12) Patent Application Publication
(10) Pub. No.: US 2009/0326140 A1
(43) Pub. Date: Dec. 31, 2009

(54) Resin Material

(76) Inventors: Yasuhito Shimada, Fukui (JP); Yasuo Kita, Osaka (JP); Toshikazu Nosaka, Osaka (JP); Yoshikazu Nakayama, Osaka (JP); Toshiyuki Okuda, Fukui (JP)

Correspondence Address: HARNESS, DICKEY & PIERCE, P.L.C., P.O. BOX 8910, RESTON, VA, 20195, US

(21) Appl. No.: 12/308,765

(22) PCT Filed: Jun. 25, 2007
(86) PCT No.: PCT/JP2007/062733

§ 371 Date: Feb. 10, 2009

(30) Foreign Application Priority Data
Jun. 23, 2006 (JP) 2006-173997

(51) Int. Cl. C08K 7/06

(52) U.S. Cl. 524/495

(57) ABSTRACT

An object is to provide a resin material having high strength and high vibration-damping property. A resin material includes a matrix resin and carbon nanocoils contained therein. The carbon nanocoils have electrical conductivity, so that the matrix resin containing them can easily convert a vibration energy generated in the resin material into heat and thereby damp the vibration energy in a short time. In addition, since the carbon nanocoil is in a coiled form, vibration-damping property can be enhanced in comparison with that of conductive materials such as carbon nanotube and graphite.

### TECHNICAL FIELD

The present invention relates to a vibration-damping resin material capable of damping vibrations rapidly and thus having high vibration-damping property, and a molded or formed product, and a vibration-damping curable resin composition that enables the preparation of the vibration-damping resin material, and a prepreg.

### BACKGROUND ART

Fiber-reinforced composite resin materials obtained by incorporating reinforced fibers in a matrix resin have been used widely for members for transport equipment or household electric appliances, or building members. These members are sometimes required to be made of a material capable of damping vibrations and thus having vibration damping property in order to prevent propagation of vibrations to members adjacent to them.

Members made of a flexible material have usually high vibration-damping property so that members made using a flexible resin or a rubber-containing resin as a matrix resin can have enhanced vibration-damping property. Use of a flexible resin as a matrix resin however reduces their strength greatly.

As a prior art of a vibration-damping material with high vibration-damping property, a vibration-damping material obtained by adding a conductive material having electrical conductivity such as carbon nanotubes or graphite to a resin is disclosed in Japanese Unexamined Patent Publications JP-A 2002-70938 and JP-A 2003-128850.

### DISCLOSURE OF INVENTION

According to the technology disclosed in JP-A 2002-70938 and JP-A 2003-128850, a vibration-damping material obtained by adding a conductive material such as carbon nanotubes or graphite to a resin can damp a vibration energy within a short time because a vibration energy generated in the material is easily converted into heat. A vibration-damping material can therefore have increased strength and vibration-damping property by containing a conductive material in its matrix resin. Conductive materials such as carbon nanotubes and graphite however tend to agglomerate due to Van der Waals' forces acting between the conductive materials so that it is difficult to disperse the conductive material uniformly in the resin. Unless the conductive material incorporated in the resin is uniformly dispersed therein, the resulting vibration-damping material cannot have sufficiently high vibration damping property. Moreover, the vibration-damping material may have reduced strength by containing the conductive material in the resin unless the conductive material is uniformly dispersed in the resin.

In the case of fiber-reinforced composite resin materials, when prepregs are laminated and used as a laminate, interlayer peeling (which may hereinafter be called “delamination”) which is parallel slip between layers may occur. The fiber-reinforced composite resin materials are therefore required to have resistance against interlayer peeling.

An object of the invention is to provide a vibration-damping resin material having high strength and high vibration-damping property and a molded or formed product made of the vibration-damping resin material.

Another object of the invention is to provide a vibration-damping curable resin composition which enables the preparation of a vibration-damping resin material having high strength and high vibration-damping property.

A further object of the invention is to provide a vibration-damping resin material having high delamination resistance and a molded or formed product made of the vibration-damping resin material.

A still further object of the invention is to provide a vibration-damping curable resin composition which enables the preparation of a vibration-damping resin material having high delamination resistance and a prepreg.

The invention is directed to a vibration-damping resin material comprising a matrix resin and carbon nanocoils contained therein,

wherein the carbon nanocoil has an axial length of 0.5 μm or greater and not greater than 100 μm,

a coiled fiber constituting the carbon nanocoil has a diameter of 10 nm or greater but not greater than 500 nm,

a coil pitch of the carbon nanocoil is 10 nm or greater but not greater than 1500 nm, and

an external diameter of the carbon nanocoil is 50 nm or greater but not greater than 1000 nm.

According to the invention, there is provided a vibration-damping resin material comprising a matrix resin and carbon nanocoils contained therein, wherein the carbon nanocoil has an axial length of 0.5 μm or greater and not greater than 100 μm, a coiled fiber constituting the carbon nanocoil has a diameter of 10 nm or greater but not greater than 500 nm, a coil pitch of the carbon nanocoil is 10 nm or greater but not greater than 1500 nm, and an external diameter of the carbon nanocoil is 50 nm or greater but not greater than 1000 nm. The carbon nanocoils have electrical conductivity, so that a matrix resin containing them can easily convert a vibration energy generated in the vibration-damping resin material into heat and thereby damp the vibration energy in a short time.

The carbon nanocoil is in a coiled form, so that compared with conductive materials, such as carbon nanotube and graphite, other than the carbon nanocoil, a contact area of the carbon nanocoils with the matrix resin is greater. The carbon nanocoils can therefore easily convert a vibration energy generated in the vibration-damping resin material into heat. Compared with the conductive materials other than the carbon nanocoil, carbon nanocoils can damp the vibration energy in a shorter time.

The carbon nanocoil is in a coiled form, so that different from conductive materials other than the carbon nanocoil, the carbon nanocoil tends to deform like a spring and restore its pre-deformation shape. In the vibration-damping resin material containing the carbon nanocoils in the matrix resin thereof, a restoring force to restore its pre-deformation shape acts on the vibration-damping resin material, whereby the vibration energy is damped. Such damping of a vibration energy attributable to the physical shape does not occur when the conductive material other than the carbon nanocoil is used but occurs when the carbon nanocoil in the coiled form is used.

In addition, when vibration is applied to the vibration-damping resin material externally, the carbon nanocoils as a bulk in the matrix resin also vibrate and consume the vibration energy by converting the vibration energy from a vibrator, for example, the matrix resin into an extraction/contraction motion or shear motion to the carbon nanocoils themselves, so that it is presumed to have a vibration-damping effect.

In the case of a composite material containing, in the matrix resin thereof, fillers of a micron size, for example, fillers having a particle size of 1 μm or greater but not greater than 100 μm, the physical property of the composite material is substantially proportionate to a filling amount of the fillers. On the other hand, when fillers of from a submicron to nano size are used, surface effect thereof surpasses volume effect thereof due to an extreme increase in the surface area relative to the volume. In addition, the carbon nanocoil is in the nano-size coiled form, so that compared with conductive materials other than the carbon nanocoil, a contact area of the carbon nanocoils with the matrix resin is greater. It is therefore presumable that even a small amount of the carbon nanocoil contributes to vibration-damping property.

Moreover, a contact area between the carbon nanocoils contained in the matrix resin is smaller than that between conductive materials other than the carbon nanocoil. Van der Waals' forces acting between the carbon nanocoils are therefore smaller than Van der Waals' forces acting between conductive materials other than the carbon nanocoil, so that the carbon nanocoils can be dispersed uniformly in the matrix resin. The resin material containing, in the matrix resin thereof, a carbon nanocoil can therefore have enhanced strength and sufficiently enhanced vibration-damping property.

A vibration-damping resin material having high strength and high vibration-damping property can therefore be obtained.

In addition, the axial length of the carbon nanocoil is 0.5 μm or greater and not greater than 100 μm. The carbon nanocoil tends to deform and restore its pre-deformation shape, so that the carbon nanocoil greatly damps a vibration energy by making use of its physical property. In addition, the carbon nanocoils can be dispersed uniformly in the matrix resin, so that they can heighten the strength of the resulting resin material and therefore sufficiently enhance the vibration-damping property thereof.

Further, the diameter of the coiled fiber constituting the carbon nanocoil is 10 nm or greater but not greater than 500 nm. The carbon nanocoil tends to deform and has a large restoring force to restore its pre-deformation shape. Therefore, it is possible to enhance the vibration-damping property of the resin material sufficiently.

Further, the coil pitch of the carbon nanocoil is 10 nm or greater but not greater than 1500 nm. When the coil pitch of the carbon nanocoil is outside the above-described range, a restoring force to restore its pre-deformation shape, which force acts during deformation of the carbon nanocoil, is small and damping of a vibration energy attributable to the physical shape does not occur sufficiently.

Further, the external diameter of the carbon nanocoil is 50 nm or greater but not greater than 1000 nm. When the external diameter of the carbon nanocoil is outside the above-described preferred range, a restoring force to restore its pre-deformation shape, which force acts during deformation of the carbon nanocoil, is small and damping of a vibration energy attributable to the physical shape does not occur sufficiently.

In the invention, it is preferable that the matrix resin contains reinforced fibers.

According to the invention, the matrix resin contains reinforced fibers. The vibration-damping resin material can therefore have further enhanced strength. In addition, the invention enables the preparation of a vibration-damping resin material having high vibration-damping property and at the same time, delamination resistance.

In the invention, it is preferable that a fiber diameter of the reinforced fibers is 3 μm or greater but not greater than 10 μm.

According to the invention, a fiber diameter of the reinforced fibers is preferably 3 μm or greater but not greater than 10 μm. Reinforced fibers having a fiber diameter below 3 μm cannot improve the strength sufficiently due to low stiffness of the reinforced fiber. Reinforced fibers having a fiber diameter exceeding 10 μm, on the other hand, do not have enough affinity with the matrix resin and therefore cannot improve the strength sufficiently.

In the invention, it is preferable that a content of the reinforced fibers is 50% by volume or greater but not greater than 60% by volume based on a total volume of the vibration-damping resin material.

According to the invention, a content of the reinforced fibers is preferably 50% by volume or greater but not greater than 60% by volume based on the total volume of the vibration-damping resin material. Contents less than 50% by volume cannot improve the strength sufficiently. Contents exceeding 60% by volume, on the other hand, prevent preparation of a vibration-damping resin material having high strength because the matrix resin is not distributed between the reinforced fibers.

In the invention, it is preferable that the matrix resin is at least one resin selected from epoxy resins, phenolic resins, unsaturated polyester resins, styrene resins, olefin resins, polyamide resins, and polycarbonate resins.

According to the invention, the matrix resin is preferably at least one resin selected from epoxy resins, phenolic resins, unsaturated polyester resins, styrene resins, olefin resins, polyamide resins, and polycarbonate resins. Use of such a resin enables the preparation of a vibration-damping resin material having both high strength and high vibration-damping property.

In the invention, it is preferable that the matrix resin is an epoxy resin.

According to the invention, the matrix resin is preferably an epoxy resin. Use of such a vibration-damping resin material as the matrix resin can exhibit both high strength and high vibration-damping property.

In the invention, it is preferable that the reinforced fibers are opened carbon fibers.

According to the invention, the reinforced fibers are preferably opened carbon fibers. The vibration-damping resin material using the opened carbon fibers can exhibit high strength and high vibration-damping property.

The invention is directed to a molded or formed product made of the vibration-damping resin material mentioned above.

According to the invention, the molded or formed product having high strength and high vibration-damping property is provided because the molded or formed product is made of a vibration-damping resin material having high strength and high vibration-damping property as described above.

The invention is directed to a vibration-damping curable resin composition comprising a matrix resin and carbon nanocoils,

wherein the carbon nanocoil has an axial length of 0.5 μm or greater and not greater than 100 μm,

a coiled fiber constituting the carbon nanocoil has a diameter of 10 nm or greater but not greater than 500 nm,

a coil pitch of the carbon nanocoil is 10 nm or greater but not greater than 1500 nm, and

an external diameter of the carbon nanocoil is 50 nm or greater but not greater than 1000 nm.

According to the invention, there is a vibration-damping curable resin composition comprising a matrix resin and carbon nanocoils, wherein the carbon nanocoil has an axial length of 0.5 μm or greater and not greater than 100 μm, a coiled fiber constituting the carbon nanocoil has a diameter of 10 nm or greater but not greater than 500 nm, a coil pitch of the carbon nanocoil is 10 nm or greater but not greater than 1500 nm, and an external diameter of the carbon nanocoil is 50 nm or greater but not greater than 1000 nm. A cured resin product containing a matrix resin and carbon nanocoils and having high strength and high vibration-damping property can be obtained by curing such a vibration-damping curable resin composition.

In the invention, it is preferable that the matrix resin contains reinforced fibers.

According to the invention, the matrix resin contains reinforced fibers. A cured resin product can therefore have further enhanced strength. In addition, the invention enables the preparation of a cured resin product having high vibration-damping property and at the same time, delamination resistance.

In the invention, it is preferable that a fiber diameter of the reinforced fibers is 3 μm or greater but not greater than 10 μm.

According to the invention, a fiber diameter of the reinforced fibers is preferably 3 μm or greater but not greater than 10 μm. Reinforced fibers having a fiber diameter below 3 μm cannot improve the strength sufficiently due to low stiffness of the reinforced fiber. Reinforced fibers having a fiber diameter exceeding 10 μm, on the other hand, do not have enough affinity with the matrix resin and therefore cannot improve the strength sufficiently.

In the invention, it is preferable that a content of the reinforced fibers is 50% by volume or greater but not greater than 60% by volume based on the total volume of the vibration-damping curable resin composition.

According to the invention, a content of the reinforced fibers is preferably 50% by volume or greater but not greater than 60% by volume based on the total volume of the vibration-damping curable resin composition. Contents less than 50% by volume cannot improve the strength sufficiently. Contents exceeding 60% by volume, on the other hand, prevent preparation of a cured resin product having high strength because the matrix resin is not distributed between the reinforced fibers.

The invention is directed to a molded or formed product obtained by curing the vibration-damping curable resin composition mentioned above.

According to the invention, the molded or formed product having high strength and high vibration-damping property is provided because the molded or formed product is obtained by curing the vibration-damping curable resin composition of the invention.

The invention is directed to a prepreg made by impregnating fibers with the vibration-damping curable resin composition and applying pressure while heating.

According to the invention, a prepreg is made by impregnating fibers with the vibration-damping curable resin composition and applying pressure while heating. By preparing a vibration-damping resin material by stacking such prepregs, it is possible to obtain a vibration-damping resin material having high strength and high vibration-damping property.

### BRIEF DESCRIPTION OF DRAWINGS

Other and further objects, features, and advantages of the invention will be more explicit from the following detailed description taken with reference to the drawings wherein:

FIG. 1 is a view showing a photograph of a carbon nanocoil taken by a scanning electron microscope (SEM);

FIGS. 2A to 2D are schematic views illustrating the preparation process of a resin material;

FIGS. 3A and 3B are schematic views for describing the measurement methods of the vibration-damping properties and strength of resin materials of the invention;

FIG. 4 is a view showing the relationship between an amplitude of a resin material and a logarithmic damping ratio;

FIG. 5 is a view showing the relationship between a bending strain and bending strength of resin materials;

FIG. 6 is a schematic view illustrating a vibration-damping property test apparatus 70;

FIG. 7 is an enlarged view of Section S17 illustrated in FIG. 6;

FIG. 8 is one example depicting a damping curve as measured by the vibration-damping property test apparatus 70;

FIG. 9 is a graph showing the relationship between a strain amplitude and a loss coefficient of a resin material;

FIG. 10 is a schematic view illustrating a free resonance Young's modulus analyzer 90;

FIG. 11 is a graph showing the relationship between a strain amplitude and a loss coefficient of a resin material in a low strain amplitude region;

FIG. 12 is a graph illustrating the relationship between a strain amplitude and a loss coefficient of a resin material in a high strain amplitude region; and

FIG. 13 is a schematic view illustrating an interlayer peeling test apparatus 110.

### BEST MODE FOR CARRYING OUT THE INVENTION

Now referring to the drawings, preferred embodiments of the invention are described below.

The invention provides a resin material comprising a matrix resin and carbon nanocoils contained therein. The resin material of the invention is a composite material having vibration-damping property. This resin material has high vibration-damping property and is therefore suited as a vibration-damping material, that is, a vibration-damping resin material. This resin material is used preferably as a material for sporting goods (such as golf shaft and tennis racket), automobile materials (such as floor panel and toe board), aviation/airspace materials, building structural materials, materials for transport equipment, materials for household electric appliances (such as washing machine and air conditioner), and materials for industrial apparatus (such as robot arm).

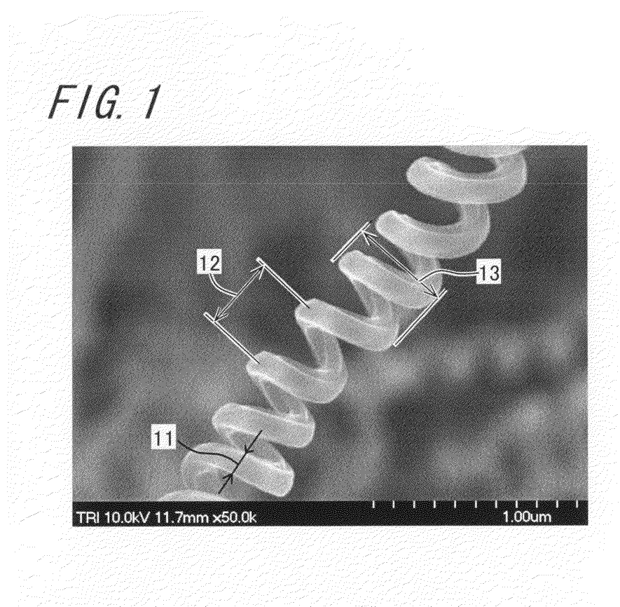

The carbon nanocoil is a carbon material and a conductive material having electrical conductivity. FIG. 1 is a view showing a photograph of a carbon nanocoil taken by a scanning electron microscope (SEM). The carbon nanocoil is, as illustrated in FIG. 1, a carbon material obtained by winding carbon atoms in a coiled form.

By incorporating the carbon nanocoils in the matrix resin, a vibration energy generated in the resin material can easily be converted into heat so that the vibration energy can be damped in a short time.

The carbon nanocoil is in the coiled form, so that compared with conductive materials, such as carbon nanotube and graphite, other than the carbon nanocoil, the contact area with the matrix resin is large. The carbon nanocoil can therefore more easily convert a vibration energy generated in the resin material into heat and damp the vibration energy in a shorter time, compared with the conductive materials other than the carbon nanocoil.

Since the carbon nanocoil is in the coiled form, the carbon nanocoil is different from conductive materials other than the carbon nanocoil and tends to deform like a spring and restore its pre-deformation shape. A resin material containing, in the matrix resin thereof, the carbon nanocoil therefore damps a vibration energy because a restoring force to restore its pre-deformation shape acts on the resin material. Such damping of a vibration energy attributable to the physical shape of the carbon nanocoil does not act on the conductive materials other than the carbon nanocoil but acts on the carbon nanocoil in the coiled form.

When vibration is applied externally to the resin material, the carbon nanocoils as a bulk in the matrix resin also vibrate and consume a vibration energy by converting the vibration energy from a vibrator, for example, the matrix resin into an extraction/contraction motion or shear motion of the carbon nanocoils themselves, so that it is presumed to have a vibration-damping effect.

In the case of a composite material containing, in the matrix resin thereof, fillers of a micron size, for example, fillers having a particle size of 1 μm or greater but not greater than 100 μm, the physical property of the composite material is substantially proportionate to a filling amount of the fillers. On the other hand, when fillers of a size from submicron to nano range are used, surface effect thereof surpasses volume effect thereof due to an extreme increase in the surface area relative to the volume. In addition, the carbon nanocoil is in the nano-size coiled form so that compared with conductive materials other than the carbon nanocoil, a contact area with the matrix resin is large. It is therefore presumed that even a small amount of the carbon nanocoil contributes to vibration-damping property.

Moreover, compared with conductive materials other than carbon nanocoil, a contact area between carbon nanocoils contained in the matrix resin is smaller. Van der Waals' forces acting between carbon nanocoils are therefore smaller than Van der Waals forces acting between conductive materials other than carbon nanocoil so that the carbon nanocoil can be dispersed uniformly in the matrix resin. The resin material containing, in the matrix resin thereof, the carbon nanocoil can therefore have enhanced strength and sufficiently enhanced vibration-damping property.

Thus, the resin material having high strength and high vibration-damping property can be obtained.

The axial length of the carbon nanocoil, that is, a length of the carbon nanocoil in the direction of an axis is preferably 0.5 μm or greater and not greater than 100 μm. When the carbon nanocoil has an axial length less than 0.5 μm, a restoring force to restore its pre-deformation shape which force acts during deformation of the carbon nanocoil is too small to cause sufficient damping of a vibration energy attributable to the physical shape. When the carbon nanocoil has an axial length greater than 100 μm, such carbon nanocoils cannot be dispersed uniformly in the matrix resin and cannot contribute to the sufficient enhancement of the vibration-damping property. In addition, incorporation of such a carbon nanocoil in the matrix resin leads to a great deterioration in the strength of the resin material. On the other hand, the carbon nanocoil having an axial length within the above-described preferred range tends to deform and has a great restoring force to restore its pre-deformation shape so that damping of a vibration energy attributable to the physical shape acts greatly. Such carbon nanocoils can be dispersed uniformly in the matrix resin, so that such carbon nanocoils can enhance the strength and the vibration-damping property of the resulting resin material sufficiently. The axial length of the carbon nanocoil is more preferably 0.5 μm or greater but not greater than 50 μm, still more preferably 0.5 μm or greater but not greater than 20 μm.

With regards to the carbon nanocoil, the diameter 11 of a coiled fiber constituting the carbon nanocoil as illustrated in FIG. 1, coil pitch 12 of the carbon nanocoil, and external diameter of the carbon nanocoil, that is, an outside dimension 13 preferably fall within the following ranges, respectively.

The diameter 11 of the coiled fiber constituting the carbon nanocoil is preferably 10 nm or greater and not greater than 500 nm. When the diameter 11 of the coiled fiber is below 10 nm, the coiled fiber constituting the carbon nanocoil has low stiffness and a restoring force to restore its pre-deformation shape, which force acts during the deformation of the carbon nanocoil, is insufficient. When it exceeds 500 nm, on the other hand, the carbon nanocoil does not deform easily because of high stiffness of the coiled fiber constituting the carbon nanocoil and damping of a vibration energy attributable to its physical shape does not occur. The carbon nanocoil comprised of the coiled fiber having a diameter within the above-described range tends to deform and has a great restoring force to restore its pre-deformation shape, so that such a carbon nanocoil can sufficiently enhance vibration-damping property. The diameter 11 of the coiled fiber constituting the carbon nanocoil is more preferably 10 nm or greater but not greater than 400 nm, still more preferably 10 nm or greater but not greater than 300 nm.

The coil pitch 12 of the carbon nanocoil is preferably 10 nm or greater but not greater than 1500 nm, more preferably 10 nm or greater and not greater than 1000 nm. When the coil pitch 12 of the carbon nanocoil is outside the above-described range, a restoring force to restore its pre-deformation shape, which force acts during deformation of the carbon nanocoil, is small and damping of a vibration energy attributable to the physical shape does not occur sufficiently. The coil pitch 12 of the carbon nanocoil is more preferably 10 nm or greater but not greater than 1000 nm, still more preferably 10 nm or greater and not greater than 600 nm.

The external diameter 13 of the carbon nanocoil is preferably 50 nm or greater but not greater than 1000 nm. When the external diameter 13 of the carbon nanocoil is outside the above-described preferred range, a restoring force to restore its pre-deformation shape, which force acts during deformation of the carbon nanocoil, is small and damping of a vibration energy attributable to the physical shape does not occur sufficiently. The external diameter 13 of the carbon nanocoil is more preferably 50 nm or greater but not greater than 900 nm, still more preferably 50 nm or greater but not greater than 700 nm.

The carbon nanocoil is prepared by thermal CVD (Chemical Vapor Deposition), more specifically, by heating an alumina substrate having a catalyst for carbon nanocoil supported thereon (which substrate will hereinafter be called “alumina substrate with catalyst”) to about 700° C. and blowing a mixed gas of a hydrocarbon such as acetylene and an inert gas to the heated alumina substrate with catalyst. The catalyst for carbon nanocoil used here is, for example, an indium/tin/iron catalyst. The indium/tin/iron catalyst is, for example, a metal hydrochloride, more specifically, a mixed oxide prepared by baking, at 400° C., a precipitate obtained by the coprecipitation of a mixed solution of an iron chloride, for example, iron trichloride (FeCl₃), an indium chloride, for example, indium trichloride (InCl₃), and a tin chloride, for example, tin dichloride (SnCl₂). As the solvent of the mixed solution, water or an alcohol such as isopropyl alcohol (abbreviation: IPA) or ethanol can be used. As the inert gas, helium or argon can be used.

As the indium/tin/iron catalyst, metal nitrates, metal sulfates or metal organic acid salts may be used as well as the metal hydrochlorides. As the catalyst for the carbon nanocoil, a mixture obtained by mixing, with the indium/tin/iron catalyst, an adequate amount of a metal oxide powder, for example, iron oxide, indium oxide or tin oxide powder may be used. The catalyst for carbon nanocoil is not limited to the above-described indium/tin/iron ternary catalyst and an indium-oxide-free catalyst, for example, a tin/iron binary catalyst, more specifically, an iron oxide/tin oxide binary catalyst may be used. The carbon nanocoil as described above can be obtained by controlling the composition of the catalyst for carbon nanocoil, growth time, heating temperature of the alumina substrate with catalyst, kind of the hydrocarbon, or the concentration or flow rate of the hydrocarbon at the time of preparation by thermal CVD.

The content of the carbon nanocoil is preferably 0.05% by weight or greater but not greater than 10% by weight, more preferably 0.05% by weight or greater but not greater than 3% by weight, each based on the weight of the matrix resin. When the carbon nanocoil content is less than 0.05% by weight based on the weight of the matrix resin, addition of the carbon nanocoil is not effective for improving the vibration-damping property. When it exceeds 10% by weight, addition of the carbon nanocoil in an amount greater than it is not effective for improving the vibration-damping property and moreover, addition of the carbon nanocoil deteriorates the strength. When the content of the carbon nanocoil is 10% by weight or greater based on the weight of the matrix resin, excessive increase in the viscosity of the resin prevents smooth kneading of the matrix resin and the carbon nanocoil. They can be kneaded smoothly when the content is not greater than 1% by weight

As the matrix resin, known resins are usable. Examples include thermosetting resins such as epoxy resins, phenolic resins, and unsaturated polyester resins; thermoplastic resins such as styrene resins and olefin resins; and engineering plastic resins such as polyamide resins and polycarbonate resins. Among them, at least one resin selected from epoxy resins, phenolic resins, unsaturated polyester resins, styrene resins, olefin resins, polyamide resins, and polycarbonate resins is preferred, with the epoxy resins being especially preferred. A resin material exhibiting high strength and high vibration-damping property can be obtained using at least one resin selected from epoxy resins, phenolic resins, unsaturated polyester resins, styrene resins, olefin resins, polyamide resins, and polycarbonate resins. The resin material can show especially high strength and high vibration-damping property by using an epoxy resin. Although no particular limitation is imposed on the epoxy resin, bisphenol A epoxy resin and phenol novolac epoxy resin are preferred.

Thus, the matrix resin may be either the thermosetting resin or the thermoplastic resin. When the thermosetting resin is used as the matrix resin, the resin material is preferably used as a prepreg. When the thermoplastic resin is used as the matrix resin, the resin material is not necessarily used as a prepreg. For example, the carbon nanocoil is dispersed in the matrix resin by kneading and the resulting dispersion is hot pressed.

The resin material preferably contains, in the matrix resin thereof, reinforced fibers. This makes it possible to heighten the strength of the resin material. In addition, the resin material having high vibration-damping property and delamination resistance can be prepared. Known fibers are usable as reinforced fibers. Examples include carbon fibers such as opened carbon fibers, glass fibers, aramid fibers, and polybenzoxazole (PBO) fibers. Among them, opened fibers are preferred, with opened carbon fibers being especially preferred. Opening of fibers accelerates impregnation of the resin and as a result, the resin material can show high strength and high vibration-damping property.

The fiber diameter of the reinforced fibers is preferably 3 μm or greater but not greater than 10 μm. Reinforced fibers having a fiber diameter below 3 μm cannot improve the strength sufficiently due to low stiffness of the reinforced fiber. Reinforced fibers having a fiber diameter exceeding 10 μm, on the other hand, do not have enough affinity with the matrix resin and therefore cannot improve the strength sufficiently.

When the matrix resin of the resin material contains reinforced fibers, the content of the reinforced fibers is preferably 50% by volume or greater but not greater than 60% by volume based on the total volume of the resin material. Contents less than 50% by volume cannot improve the strength sufficiently. Contents exceeding 60% by volume, on the other hand, prevent preparation of a resin material having high strength because the matrix resin is not distributed between the reinforced fibers.

The resin material of the invention may contain, in addition to the matrix resin, the carbon nanocoil, and the reinforce fibers, a nanocarbon composition other than the carbon nanocoil. Examples of the nanocarbon composition other than the carbon nanocoil include carbon nanotube, carbon nanofiber, carbon black, and fullerene. When the resin material of the invention contains a nanocarbon composition other than the carbon nanocoil, the content of the nanocarbon composition is preferably 0.05% by weight or greater but not greater than 10% by weight based on the weight of the matrix resin, meaning that the content is preferably 0.05% by weight or greater but not greater than 10% by weight assuming that the weight of the matrix resin is 100% by weight.

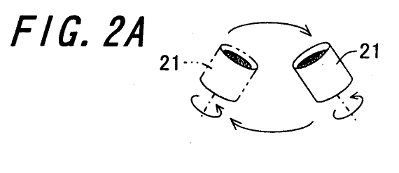

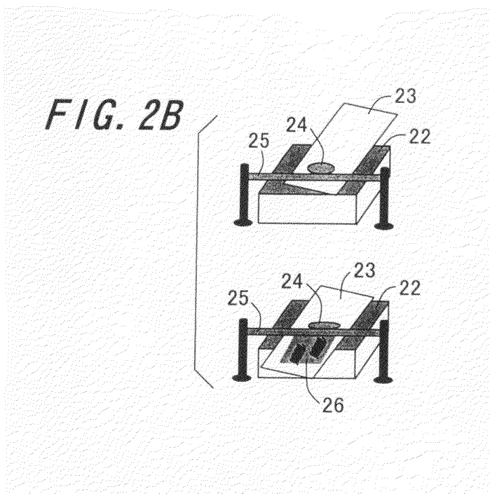

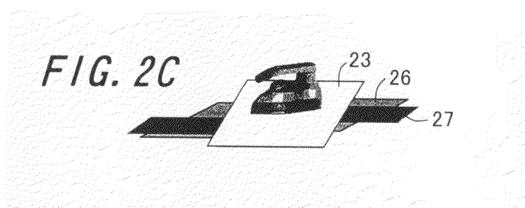

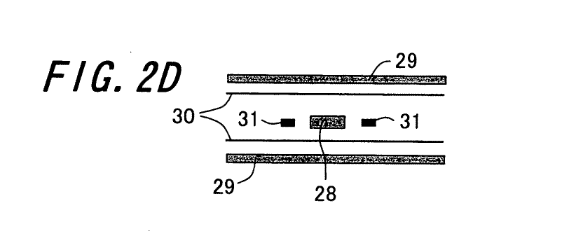

A preparation process of the resin material will next be described. FIGS. 2A to 2D are schematic views illustrating the preparation process of the resin material. FIGS. 2A to 2D illustrate one preparation example of a resin material containing, in the matrix resin thereof, reinforced fibers.

First, as illustrated in FIG. 2A, an epoxy resin serving as the matrix resin and a carbon nanocoil are charged in a vessel 21 of a planetary centrifugal mixer (“AR-250”, product of Thinky Corporation) and kneaded to disperse the carbon nanocoil in the matrix resin. The revolution speed of the vessel 21 is set at 2000 rpm and the rotation speed thereof is set at 800 rpm. The revolution and rotation speeds of the vessel 21 are not limited to the above values.

An auxiliary agent is added to the resulting dispersion obtained by dispersing the carbon nanocoil in the matrix resin. As illustrated in FIG. 2B, a release paper 23 is placed on a glass plate 22 heated with a heater and the dispersion 24 containing the auxiliary agent is added dropwise onto the release paper 23, followed by formation into a thin layer by using a bar coater 25. “WBE90R-DT-B”, product of Lintec Corporation is used as the release paper 23, while a bar coater No. 9, product of Daiichi Rika Co., Ltd. is used as the bar coater 25, respectively. The release paper 23 and the bar coater 25 are however not limited to them.

A prepreg is then made by impregnating carbon fibers 27 with the dispersion 26 formed into a thin layer and applying pressure while heating as illustrated in FIG. 2C.

As illustrated in FIG. 2D, a plurality of the prepregs 28 thus made are stacked one after another, followed by insertion between mirror-finish stainless plates 29 to make a laminated plate (resin material). In order to prevent direct contact of the prepregs 28 with the stainless plate 29, a tedlar film 30 is laid on the stainless plate 29. In addition, to control the thickness of the laminated sheet, a spacer 31 having a thickness of 2 mm is inserted, together with the prepreg 28, between the stainless plates. The thickness of the spacer 31 is not limited to the above-described value.

The resin material not containing, in the matrix resin thereof, reinforced fibers is prepared, for example, in the following manner. In a similar manner to that employed for the resin material containing reinforced fibers, an auxiliary agent is added to a dispersion obtained by dispersing a carbon nanocoil in the matrix resin to prepare a dispersion of a carbon-nanocoil-containing resin (abbreviation of carbon nanocoil: CNC). The dispersion of a CNC-containing resin thus prepared is cast in a mold with a desired shape and cured by heating in a drier. A resin material is thus obtained as a molded resin having the desired shape.

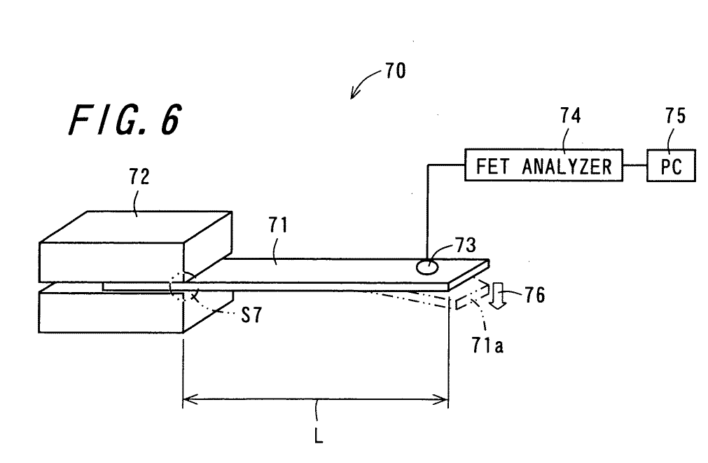

The resin material of the invention has a loss coefficient (η), as measured using vibration-damping property test apparatus 70 of FIG. 6 which will be described later, of preferably 0.5% or greater but not greater than 10%. When the loss coefficient (η) is less than 0.5%, the resin material does not effectively damp vibration as a vibration-damping material. When the loss coefficient (η) exceeds 10%, there is fear that deterioration in mechanical strength of the material itself occurs. Loss coefficients (η) of 0.5% or greater but not greater than 10% enable the improvement in both physical properties, that is, mechanical strength and vibration-damping property. Addition of the carbon nanocoil to the matrix resin enables the preparation of a resin material having a loss coefficients (η) of 0.5% or greater but not greater than 10%. The loss coefficients (η) of the resin material of the invention is more preferably 1.5% or greater but not greater than 10%, still more preferably 2.5% or greater but not greater than 10%.

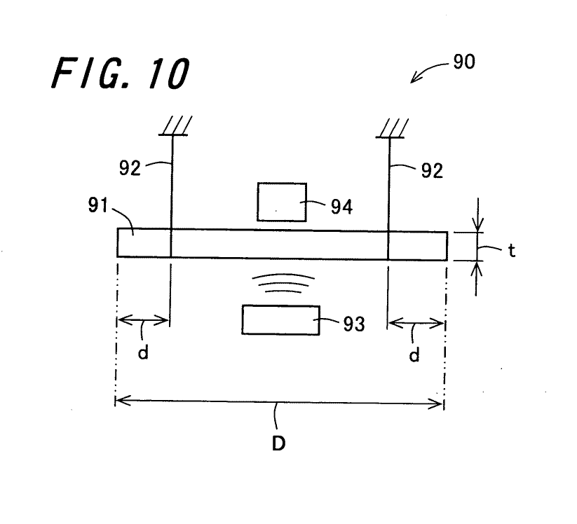

The resin material of the invention has an elastic modulus, as measured using a free resonance Young's modulus analyzer 90 of FIG. 10 which will be described later, of preferably 1 GPa or greater but not greater than 80 GPa. When the elastic modulus is less than 1 GPa, there is a fear that deterioration in mechanical strength occurs. When the elastic modulus exceeds 80 GPa, the resulting resin material has difficulty in damping vibration. Elastic moduli of 1 GPa or greater but not greater than 80 GPa enable the improvement in both physical properties, that is, mechanical strength and vibration-damping property. Addition of the carbon nanocoil to the matrix resin enables the preparation of a resin material having an elastic modulus of 1 GPa or greater but not greater than 80 GPa. The elastic moduli of the resin material of the invention is more preferably 15 GPa or greater but not greater than 80 GPa.

The resin material of the invention has an interlaminar shear strength, as measured by an interlayer peeling test by a short beam method in accordance with Japanese Industrial Standards (JIS) K7078, of preferably 20 MPa or greater but not greater than 200 MPa. When the interlaminar shear strength is less than 20 MPa, there is a fear that deterioration in mechanical strength occurs. When the interlaminar shear strength exceeds 200 MPa, on the other hand, there is a danger of plastic deformation and fracture. Interlaminar shear strength of 20 MPa or greater but not greater than 200 MPa enables the improvement in both physical properties, that is, mechanical strength and vibration-damping property. Addition of the carbon nanocoil to the matrix resin enables the preparation of a resin material having an interlaminar shear strength of 20 MPa or greater but not greater than 200 MPa. The interlaminar shear strength of the resin material of the invention is more preferably 50 MPa or greater but not greater than 200 MPa.

Molding or forming materials and molded or formed products composed of the above-described resin material of the invention are also embraced in the invention. The resin material of the invention has, as described above, high strength and high vibration-damping property. Since the molding or forming materials are made of the resin material of the invention, they have high strength and high vibration-damping property. Since the molded or formed products are made of the resin material of the invention, they have high strength and high vibration-damping property. The molding materials made of the resin material of the invention embrace prepregs made of the resin material of the invention and pellets made of the resin material of the invention.

The invention provides a curable resin composition that contains the matrix resin and the carbon nanocoils. The above-described dispersion which will be a resin material of the invention is one embodiment of the curable resin composition of the invention.

The content of the carbon nanocoil in the curable resin composition of the invention is, similar to the content of the carbon nanocoil in the resin material of the invention, preferably 0.05% or greater but not greater than 10%, more preferably 0.05% by weight or greater but not greater than 3% by weight based on the weight of the matrix resin. The content of the carbon nanocoil is a value, assuming that the weight of the matrix resin is 100% by weight.

The curable resin composition of the invention may contain, in addition to the matrix resin and the carbon nanocoil, an auxiliary agent. Examples of the auxiliary agent include epoxidized alpha-olefin and epoxy reactive diluents. A commercially available product of epoxidized alpha-olefin is, for example, “VIKOLOX10” (trade name), product of Kitamura Chemicals Co., Ltd. and a commercially available product of the epoxy reactive diluent is, for example, “YED216” (trade name) product of Japan Epoxy Resins Co., Ltd. The content of the auxiliary agent is, for example, 5% by weight based on the weight of the matrix resin. The content of the auxiliary agent is not limited to this value, but it is preferably 0.5% by weight or greater but not greater than 10% by weight based on the weight of the matrix resin, more specifically, 0.5% by weight or greater but not greater than 10% by weight assuming that the weight of the matrix resin is 100% by weight.

### Examples

The present invention will hereinafter be described specifically by Examples and Comparative Examples.

### Preparation Example

A catalyst solution was prepared by dissolving 151.94 g of ferric nitrate nonhydrate (Fe(NO₃)₃.9H₂O), 42.11 g of indium nitrate trihydrate (In(NO₃).3H₂O), and 1.30 g of tin oxalate (SnC₂O₄) in 600 mL of ethanol. The catalyst solution thus obtained was applied to the surface of an alumina substrate serving as a substrate for growth by using a spin coater to form a thin layer having a thickness of 200 nm. The thin layer was then dried for 30 minutes at a temperature of 100° C., followed by baking at a temperature of 400° C. for 1 hour to prepare an alumina substrate having a carbon nanocoil catalyst supported thereon (which will hereinafter be called “alumina substrate with catalyst”).

The resulting alumina substrate with catalyst was heated to about 700° C. A mixed gas of acetylene and argon was blown to the heated alumina substrate with catalyst to make the carbon nanocoil grow by thermal CVD. In the carbon nanocoil thus obtained, the axial length was 12 μm, the diameter 11 of the coiled fiber constituting the carbon nanocoil was 200 nm, the coil pitch 12 of the carbon nanocoil was 450 nm, and the external diameter 13 of the carbon nanocoil was 450 nm.

### Example 1

In Example 1, a resin material was prepared in accordance with the preparation process shown above in FIGS. 2A to 2D. The resin material of Example 1 contains 0.5% by weight of a carbon nanocoil based on the weight of a matrix resin. The content of reinforced fibers is 57% by volume based on the total volume of the resin material. In the carbon nanocoil used in this example, the axial length is 12 μm, the diameter 11 of the coiled fiber constituting the carbon nanocoil is 200 nm, the coil pitch 12 of the carbon nanocoil is 450 nm, and the external diameter 13 of the carbon nanocoil is 450 nm. As the matrix resin, an epoxy resin (product of Japan Epoxy Resins Co., Ltd., “EPICOAT 828”, “EPICOAT 1001”, and “EPICOAT 154”, curing agent: “DICY”, curing accelerator: “DCMU”) was used; as the reinforced fibers, opened carbon fibers (“BESFIGHT IM600”, trade name; product of Toho Tenax Co., Ltd.) were used; and as the auxiliary agent, an epoxidized alpha-olefin (“VIKOLOX10”, product of Kitamura Chemicals Co., Ltd.) was used. The opened carbon fibers have a fiber diameter of 5 μm. A laminated plate, the resin material of Example 1, was prepared by stacking 56 prepregs. The laminated plate (resin material) thus obtained had a 0°/90° laminate structure, that is, a structure in which fiber directions of the reinforced fibers were at right angles to each other.

### Comparative Example 1

In a similar manner to Example 1 except that the carbon nanocoil was replaced by a carbon nanotube (“CMA-0405251”, product of Carbolex Inc.) and “VIKOLOX10” was replaced by an epoxy reactive diluent (“YED216”, product of Japan Epoxy Resins Co., Ltd.) as an auxiliary agent, a resin material was prepared.

### Comparative Example 2

In a similar manner to Example 1 except that a carbon nanocoil was not incorporated in the matrix resin, a resin material was prepared.

### Comparative Example 3

In a similar manner to Comparative Example 1 except that a carbon nanotube was not incorporated in the matrix resin, a resin material was prepared.

[Evaluation 1]

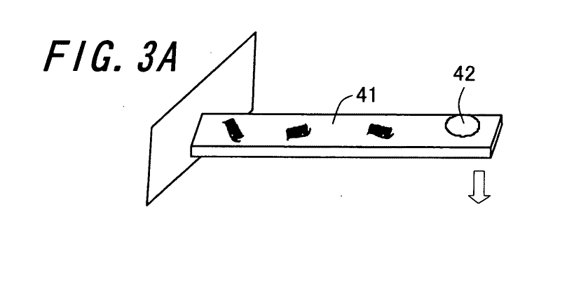

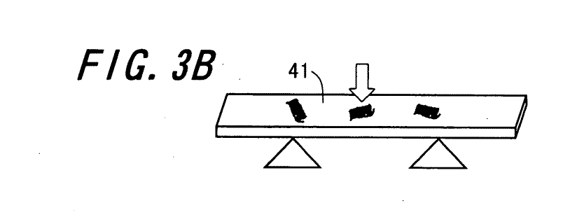

The vibration-damping properties and strength of the resin materials obtained in Example 1 and Comparative Examples 1 to 3 were studied. FIGS. 3A and 3B are schematic views for describing the measurement methods of the vibration-damping properties and strength of the resin materials of the invention. FIG. 3A is a schematic view for describing the measurement method of vibration-damping properties, while FIG. 3B is a schematic view for describing the measurement method of strength.

(Vibration-Damping Property)

As illustrated in FIG. 3A, one end portion of a resin material 41 was fixed and vibration was applied by flicking the other end with a finger. The acceleration of the vibration was determined using an acceleration meter 42 placed at the other end portion of the resin material 41. As the acceleration meter 42, an acceleration meter (“Acceleration sensor 3121BG”, product of Dytran Instruments Inc.) was used. A wave amplitude was determined from the acceleration of the vibration determined using the acceleration meter 42 and a logarithmic damping ratio was calculated. It should be noted that when the logarithmic damping ratio is greater, the vibration damping is greater and the vibration-damping property is higher.

(Strength)

The strength of the resin material was measured by three-point bending test (in accordance with JIS K 7074) as illustrated in FIG. 3B.

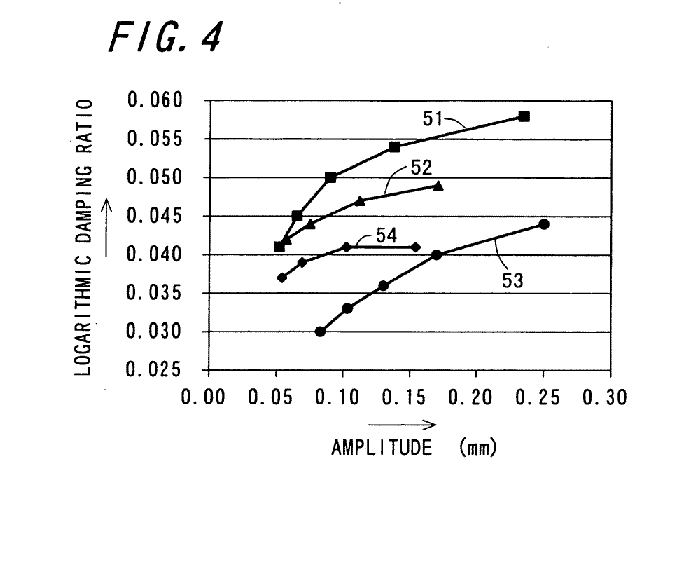

FIG. 4 shows the relationship between the amplitude of a resin material and a logarithmic damping ratio. The logarithmic damping ratio is plotted along the ordinate, while the amplitude (mm) is plotted along the abscissa. The curve 51 shows the results of Example 1; the curve 52 shows the results of Comparative Example 1; the curve 53 shows the results of Comparative Example 2; and the curve 54 shows the results of Comparative Example 3.

It is apparent from FIG. 4 that the resin material (Example 1) containing, in the matrix resin thereof, the carbon nanocoil shows considerably high vibration-damping property. The resin material (Comparative Example 1) containing, in the matrix resin, a carbon nanotube, that is, a conductive material, on the other hand, has improved vibration-damping property over the resin materials (Comparative Example 2 and Comparative Example 3) not containing, in the matrix resin, a conductive material, but its vibration-damping property is lower than those of the resin material of Example 1.

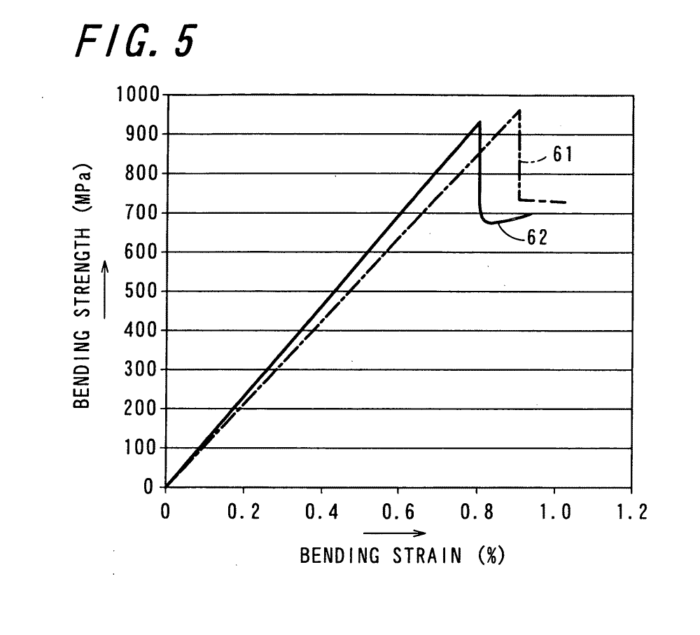

FIG. 5 is a view showing the relationship between the bending strain and bending strength of resin materials. The bending strength (MPa) is plotted along the ordinate, while the bending strain (%) is plotted along the abscissa. The curve 61 shows the results of Example 1, while the curve 62 shows the results of Comparative Example 2. The bending strength (stiffness) of the resin material of Comparative Example 1 is substantially similar to that of the resin material obtained in Example 1 because the latter one has a natural frequency of 200 Hz and the former one has a natural frequency of 202 Hz.

It is apparent from FIG. 5 that the maximum bending stress of the resin material of Example 1 is 950 MPa, while the maximum bending stress of the resin material of Comparative Example 2 is 935 MPa. This suggests that even addition of the carbon nanocoil to the epoxy resin serving as the matrix resin does not deteriorate but improves the strength of the resin material.

### Example 2

The resin material of Example 2 is a resin material not containing, in the matrix resin thereof, reinforced fibers.

As the resin material of Example 2, a test piece in the rectangular plate form was made by preparing the above-described dispersion of a CNC-containing resin by using materials described later, casting the resulting dispersion of a CNC-containing resin into a mold made of polytetrafluoroethylene (trade name, TEFLON (trade mark)) and fully curing it in a drier. The test piece was made to have a long side of 90 mm, a short side of 15 mm, and a thickness of 2 mm.

The resin material of Example 2 contains a carbon nanocoil in an amount of 0.5% by weight based on the weight of the matrix resin. Herein, the axial length of the carbon nanocoil used is 12 μm, the diameter 11 of the coiled fiber constituting the carbon nanocoil is 200 nm, the coil pitch 12 of the carbon nanocoil is 450 nm, and the external diameter 13 of the carbon nanocoil is 450 nm. The carbon nanocoil was prepared as described above by thermal CVD. As the matrix resin, three epoxy resins (“EPICOAT 828”, “EPICOAT 1001”, “EPICOAT 154”, each product of Japan Epoxy Resins Co., Ltd., curing agent: “DICY”, curing accelerator: “DCMU”) were used and as an auxiliary agent, an epoxy reactive diluent (“YED216”, product of Japan Epoxy Resins Co., Ltd.) was used. “EPICOAT 828” and “EPICOAT 1001” are bisphenol A type epoxy resins, while “EPICOAT 154” is a phenol novolac epoxy resin. “EPICOAT 828” is a liquid at normal temperature (25° C.), while “EPICOAT 1001” and “EPICOAT 154” are each a solid at normal temperature (25° C.). “EPICOAT 828” has a number average molecular weight of 330, “EPICOAT 1001” has a number average molecular weight of 900, and “EPICOAT 154” has a number average molecular weight of 530.

### Example 3

In a similar manner to Example 2 except that the content of the carbon nanocoil was changed to 1.0% by weight based on the weight of the matrix resin, a test piece of a resin material of Example 3 was made.

### Comparative Examples 4 to 7

In a similar manner to Example 2 except that the carbon nanocoil was replaced by a carbon nanotube (“CMA-0405251”, trade name; product of Carbolex Inc.), carbon black (“SEAST 9U SAF”, trade name; product of Tokai Carbon Co., Ltd.), carbon nanofiber (“VGCF”, trade name; product of Showa Denko K. K.), and fullerene (“MIXED FULLERENE Lot. 060120”, trade name; product of Honjo Chemical Corporation), test pieces of resin materials of Comparative Examples 4 to 7 were made, respectively.

### Comparative Example 8

In a similar manner to Example 2 except that the carbon nanocoil was replaced by carbon black (“SEAST 9U SAF”, trade name; product of Tokai Carbon Co., Ltd.) and the content of carbon black was adjusted to 5.0% by weight based on the weight of the matrix resin, a test piece of a resin material of Comparative Example 8 was made.

### Comparative Example 9

In a similar manner to Example 2 except that the carbon nanocoil was replaced by fullerene (“MIXED FULLERENE Lot. 060120”, trade name; product of Honjo Chemical Corporation) and the content of fullerene was adjusted to 2.0% by weight based on the weight of the matrix resin, a test piece of a resin material of Comparative Example 9 was made.

### Comparative Example 10

In a similar manner to Example 2 except that a carbon nanocoil was not incorporated in the matrix resin, in other words, a conductive material was not incorporated in the matrix resin, a test piece of Comparative Example 10 was made.

[Evaluation 2]

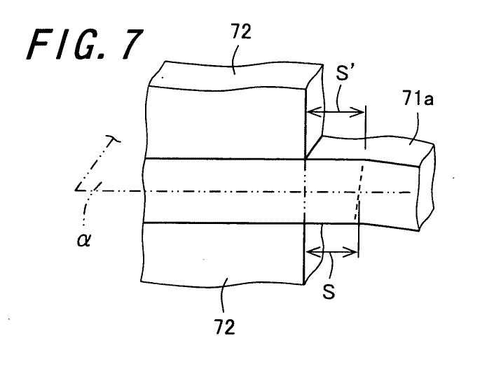

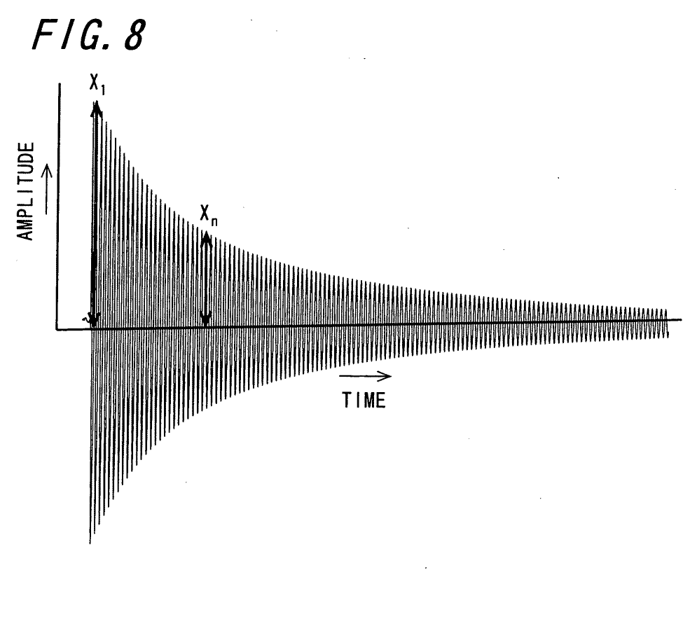

The vibration-damping property of each of the resin materials obtained in Examples 2 and 3, and Comparative Examples 4 to 10 were studied. In Evaluation 2, the vibration-damping properties were evaluated based on the relationship between a strain amplitude (ε) and a loss coefficient (η) of the resin material. FIGS. 6 to 9 depict a method how to determine the strain amplitude and loss coefficient of the resin material. FIG. 6 is a schematic view illustrating a vibration-damping property test apparatus 70. FIG. 7 is an enlarged view of Section S17 illustrated in FIG. 6. FIG. 8 is one example depicting a damping curve as measured by the vibration-damping property test apparatus 70. In FIG. 8, time is plotted along the abscissa, while a wave amplitude is plotted along the ordinate.

As illustrated in FIG. 6, one end portion, in a longitudinal direction, of a test piece 71 was fixed while inserting it in a test piece fixing vice 72. An acceleration meter 73 was placed at the other end portion of the test piece 71. Vibration was applied by flicking a finger at the other end portion, in the longitudinal direction, of the test piece 71 in a direction of an arrow 76 parallel to the thickness direction of the test piece 71. The acceleration of vibration was measured using the acceleration meter 73 placed at the other end portion, in the longitudinal direction, of the test piece 71. As the acceleration meter 73, an acceleration meter (“ACCELERATION SENSOR 3121BG”, trade name; product of Dytran Instruments Inc.) was used. In the present evaluation, the length (which will hereinafter be called “protruding length”) L of the test piece 71 from the test piece fixing vice 71 was set at 70 mm and acceleration was set at 4.5×10⁵ mm/sec.

The acceleration of vibration measured using the acceleration meter 73 is input into an information processor 75 via a fast Fourier transform (abbreviation: FFT) analyzer 74. As the information processor 75, for example, a personal computer (abbreviation: PC) is employed. The vibration amplitude is determined using the information processor 75 from the acceleration of the vibration measured by the acceleration meter 73 and a damping curve as illustrated in FIG. 8 was determined. The damping curve is displayed on a display means which the information processor 75 has.

A logarithmic damping ratio (Λ) at each amplitude (Xn) was calculated from the damping curve thus determined in accordance with the following equation (1). The symbol [n] means an integer of 2 or greater and denotes the number of peaks in the damping curve. The symbol [Xn] means an amplitude of the n-th peak. The symbol [ln] means a natural logarithm.

$$\begin{matrix}[ Equation 1 ] & \\ Λ = \frac{1}{n - 1} ln ( \frac{{X}_{1}}{X n} ) & ( 1 )\end{matrix}$$

A loss coefficient (η) at each amplitude (Xn) was calculated from the logarithmic damping ratio (Λ) based on the following equation (2). When the loss coefficient (η) is greater, the vibration damping is greater and the vibration-damping properties are higher.

η=Λ/π (2)

From the damping curve thus determined, a strain amplitude (ε) at each amplitude (Xn) was calculated based on the following equation (3). In the equation (3), the symbol [t] means a thickness of a test piece.

$$\begin{matrix}[ Equation 2 ] & \\ ɛ = \frac{3 \times t \times X n}{2 \times {L}^{2}} & ( 3 )\end{matrix}$$

The strain amplitude (ε) is represented by the following equation (4). In the equation (4), under the conditions shown by a reference numeral 71a under which the test piece 72 is bent as illustrated in FIG. 7, the symbol [S] means a reference length at a elongation-free neutral plane α and the symbol [S′] means a reference length at a surface on one side of the test piece 72 in the thickness direction. In the equation (4), [S′−S] represents elongation at the surface on one side of the test piece 72 in a thickness direction.

$$\begin{matrix}[ Equation 3 ] & \\ ɛ = \frac{{S}^{′} - S}{S} & ( 4 )\end{matrix}$$

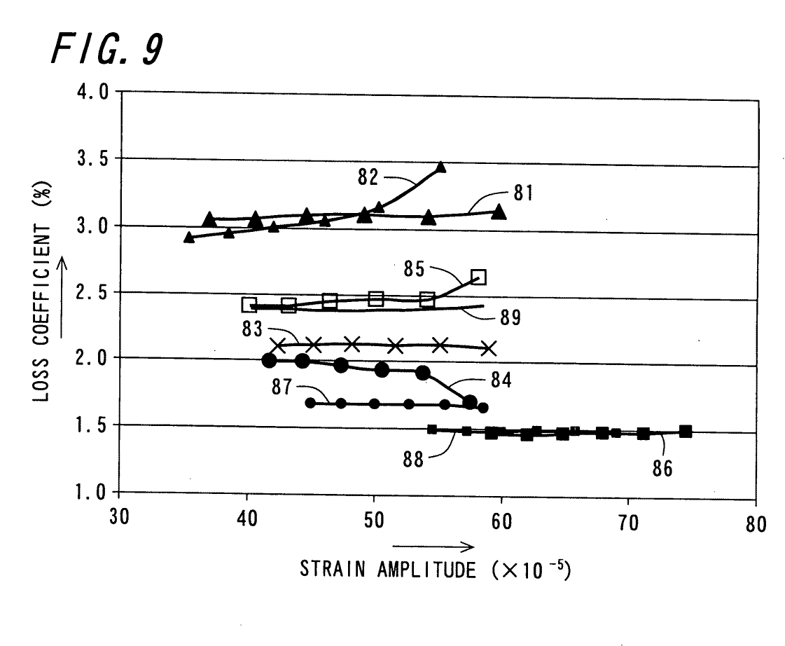

FIG. 9 is a graph showing the relationship between a strain amplitude and a loss coefficient of a resin material. In FIG. 9, the loss coefficient (%) is plotted along the ordinate and the strain amplitude (×10⁻⁵) is plotted along the abscissa. In FIG. 9, the results of Example 2 (carbon nanocoil: 0.5% by weight) are shown as a curve 81, the results of Example 3 (carbon nanocoil: 1.0% by weight) are shown as a curve 82, the results of Comparative Example 4 (carbon nanotube: 0.5% by weight) are shown as a curve 83, the results of Comparative Example 5 (carbon black: 0.5% by weight) are shown as a curve 84, the results of Comparative Example 6 (carbon nanofiber: 0.5% by weight) are shown as a curve 85, the results of Comparative Example 7 (fullerene: 0.5% by weight) are shown as a curve 86, the results of Comparative Example 8 (carbon black: 5.0% by weight) are shown as a curve 87, the results of Comparative Example 9 (fullerene: 2.0% by weight) are shown as a curve 88, and the results of Comparative Example 10 (containing no conductive material) are shown as a curve 89.

In FIG. 9, only fullerene-containing systems of Comparative Examples 7 and 9 shown, respectively, as curves 86 and 88 shift in a high strain amplitude region, which is caused by strong flicking of the test piece. As is apparent from FIG. 9, resin materials obtained in Comparative Examples 7 and 9 are almost free from dependence on the amplitude so that they are presumed to have an equal loss coefficient even in a low strain amplitude region.

It is apparent from FIG. 9 that resin materials containing, in the matrix resin thereof, a carbon nanocoil have considerable high vibration-damping properties as those of Example 2 and 3 shown respectively as the curves 81 and 82. Even if the resin materials of Comparative Examples 4 to 9 contain as a conductive material carbon nanotube, carbon nanofiber, carbon black or fullerene, only the resin material of Comparative Example 6 shown as the curve 85 and containing carbon nanofiber has higher vibration-damping properties than the resin material of Comparative example 10 shown as the curve 89 not containing, in the matrix resin thereof, a conductive material. Any of the resin materials of Comparative Examples 4 to 9 shown as the curves 83 to 88, which include the resin material of Comparative Example 6, has lower vibration-damping property than those obtained in Examples 2 and 3.

### Example 4

In a similar manner to Example 2 except that the shape of a test piece was changed to a strip, a test piece was made. The test piece was 70 mm long, 15 mm wide and 2 mm thick.

### Comparative Example 11

In a similar manner to Example 4 except that a carbon nanocoil was not incorporated in the matrix resin, a test piece of Comparative Example 11 was made.

[Evaluation 3]

An elastic modulus of each of the resin materials obtained in Example 4 and Comparative Example 11 was studied. In Evaluation 3, an elastic modulus was measured using a free resonance Young's modulus analyzer. FIG. 10 is a schematic view illustrating the free resonance Young's modulus analyzer 90.

As illustrated in FIG. 10, a test piece 91 is placed so that the thickness direction thereof is parallel to a vertical direction. Nodes which do not vibrate are supported by two wires 92 in a longitudinal direction of the test piece 91 in the strip form. An alternating electrical coulombic force is applied to the test piece 91 in a contactless manner from below in the vertical direction by using an electrostatic driving machine 93 and it is detected using a sonic detector 94 placed above in the vertical direction of the test piece 91. Then, a resonance frequency is calculated. The node of the test piece 91 is placed at a position so that a distance d from one end or the other end of the test piece 91 in the longitudinal direction is 0.224 time (0.224·D) the length D of the test piece 91.

From the resonance frequency thus calculated, a natural frequency (f) was determined and based on the following equation (5), an elastic modulus (E) was calculated. In the equation (5), the symbol “k” represents a width of a test piece, the symbol “t” represents a thickness of the test piece, and the symbol “m” represents mass of the test piece. The test piece used in the present evaluation had a mass of 3.298 g.

$$\begin{matrix}[ Equation 4 ] & \\ E = \frac{0.9467 \cdot {D}^{3} \cdot {f}^{2} \cdot m}{k \cdot {t}^{3}} & ( 5 )\end{matrix}$$

The measurement results are shown in Table 1. From Table 1, it is apparent that compared with the resin material of Comparative Example 11 not containing a conductive material, the resin material obtained in Example 4 containing, in the matrix resin, thereof, a carbon nanocoil has a markedly high elastic modulus.

TABLE 1

| | Conductive material | Elastic modulus (GPa) |
|---|---|---|
| Example 4 | Carbon nanocoil | 21.0 |
| Comp. Ex. 11 | None | 12.9 |

### Example 5

In a similar manner to Example 1 except that the content of the reinforced fibers was changed to 50% by volume based on the total volume of the resin material, “VIKOLOX10” used as an auxiliary agent was replaced by an epoxy reactive diluent (“YED216”, trade name; product of Japan Epoxy Resins Co., Ltd.), and the laminate structures were all 0° direction system structures, more specifically, the fiber directions of reinforced fibers in each prepreg were parallel to each other, a resin material of Example 5 was obtained. In Example 5, two test pieces for measurement of a low strain amplitude region and for measurement of a high strain amplitude resin were made.

These two test pieces were each in the rectangular plate form. The test piece for the measurement of a low strain amplitude region had a long side of 100 mm, a short side of 15 mm, and a thickness of 2 mm, while the test piece for the measurement of a high strain amplitude region had a long side of 200 mm, a short side of 12.5 mm, and a thickness of 1 mm. The 2-mm thick test piece for the measurement of a low strain amplitude region was made using a spacer having a thickness of 2 mm as the spacer 31 illustrated in FIG. 2D and the 1-mm thick test piece for the measurement of a high strain amplitude region was made using a spacer having a thickness of 1 mm as the spacer 31 illustrated in FIG. 2D.

### Comparative Example 12

In a similar manner to Example 5 except that the carbon nanocoil was replaced by a carbon nanofiber (“VGCF”, trade name; product of Showa Denko K. K.), a resin material of Comparative Example 12 was prepared. In Comparative Example 12, only a 1-mm thick test piece for the measurement of a high strain amplitude region was made.

### Comparative Example 13

In a similar manner to Example 5 except that a carbon nanocoil was not incorporated in the matrix resin, in other words, a conductive material was not incorporated in the matrix resin, a resin material of Comparative Example 13 was prepared.

[Evaluation 4]

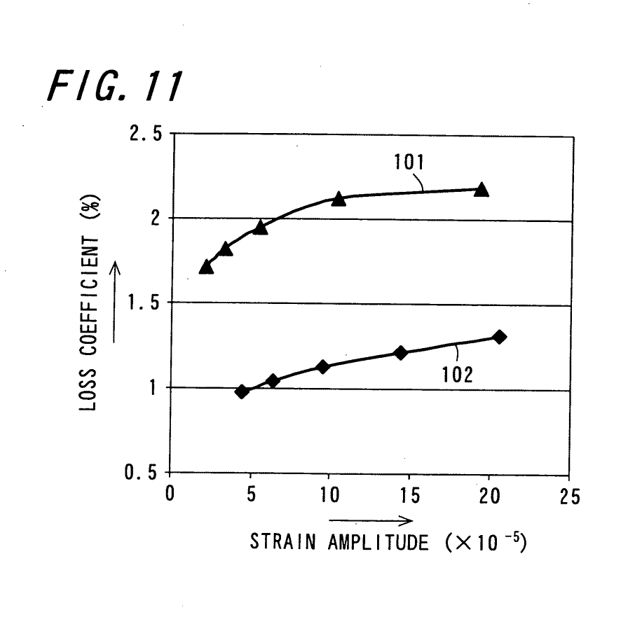

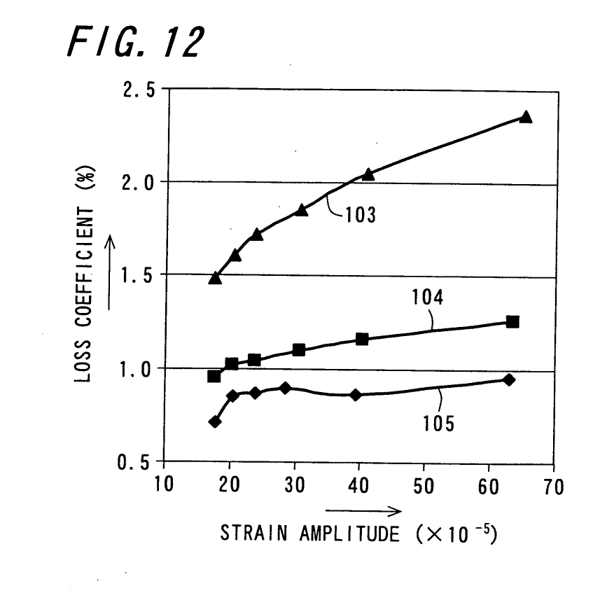

Vibration-damping property of each of the resin materials obtained in Example 5 and Comparative Examples 12 and 13 were studied. The relationship between the strain amplitude (ε) and loss coefficient (η) of the resin material was determined using the vibration-damping property test apparatus 70 illustrated in FIG. 6 in a similar manner to Evaluation 2 and based on this relationship, the vibration-damping properties were evaluated. In the present evaluation, since there were two standards for a test piece size, that is, for the measurement of a low strain amplitude region and for the measurement of a high strain amplitude region, the two measurement regions were adjusted by changing the protruding length L and acceleration of the test piece. With regard to the resin material of Comparative Example 12, measurement was performed only in the high strain amplitude region. The measurement results are shown in FIGS. 11 and 12.

FIG. 11 is a graph showing the relationship between a strain amplitude and a loss coefficient of a resin material in a low strain amplitude region. FIG. 12 is a graph illustrating the relationship between a strain amplitude and a loss coefficient of a resin material in a high strain amplitude region. In FIGS. 11 and 12, the loss coefficient (%) is plotted along the ordinate, while the strain amplitude (×10⁻⁵) is plotted along the abscissa. In FIG. 11, the curve 101 shows the results of Example 5 (carbon nanocoil: 0.5% by weight) and the curve 102 shows the results of Comparative Example 13 (not containing a conductive material). In FIG. 12, the curve 103 shows the results of Example 5 (carbon nanocoil: 0.5% by weight), the curve 104 shows the results of Comparative Example 12 (carbon nanofiber: 0.5% by weight), and the curve 105 shows the results of Comparative Example 13 (containing no conductive material).

FIGS. 11 and 12 have revealed that in each of the low strain amplitude region and high strain amplitude region, the resin material of Example 5 containing, in the matrix resin thereof, a carbon nanocoil retains a high loss coefficient and is therefore excellent in vibration-damping property.

### Example 6

In a similar manner to Example 1 except that the content of reinforced fibers, based on the total volume of the resin material, was changed to 45% by volume and “VIKOLOX10” used as an auxiliary agent was replaced by an epoxy reactive diluent (“YED216”, trade name; product of Japan Epoxy Resins Co., Ltd.), a resin material of Example 6 was prepared. The laminated plate, the resin material of Example 6, has a 0°/90° system laminate structure, that is, a structure in which fiber directions of the reinforced fibers are at right angles to each other. To facilitate interlayer peeling in an interlayer peeling test in Evaluation 5 which will be described later, the laminated plate (resin material) was formed with a 0°/90° system laminate structure. In Example 6, a test piece in the rectangular plate form was made. The test piece had a long side of 14 mm, a short side of 10 mm, and a thickness of 2 mm. The resin material of Example 6 contains, in the matrix resin thereof, a carbon nanocoil and contains opened carbon fibers as reinforced fibers.

### Comparative Example 14

In a similar manner to Example 6 except that a carbon nanocoil was not incorporated in the matrix resin, in other words, a conductive material was not incorporated in the matrix resin, a resin material of Comparative Example 14 was prepared. The resin material of Comparative Example 14 contained, in the matrix resin thereof, opened carbon fibers as reinforced fibers but did not contain a conductive material.

### Example 7

In a similar manner to Example 6 except for the use of, as the reinforced fibers, unopened carbon fibers (“BESFIGHT IM600”, trade name; product of Toho Tenax Co., Ltd.) instead of the opened carbon fibers, a resin material of Example 7 was prepared. The resin material of Example 7 contains, in the matrix resin thereof, a carbon nanocoil and also, as reinforced fibers, unopened carbon fibers.

### Comparative Example 15

In a similar manner to Example 6 except that as the reinforced fibers, unopened carbon fibers (“BESFIGHT IM600”, trade name; product of Toho Tenax Co., Ltd.) were used instead of the opened carbon fibers and a carbon nanocoil was not incorporated in the matrix resin, in other words, a conductive material was not incorporated in the matrix resin, a resin material of Comparative Example 15 was prepared. The resin material of Comparative Example 15 contains, in the matrix resin thereof, unopened carbon fibers as the reinforced fibers but no conductive material.

[Evaluation 5]

Interlaminar shear strength of each of the resin materials obtained in Examples 6 and 7 and Comparative Examples 14 and 15 was studied. In the present evaluation, an interlayer peeling test was performed by a short beam method in accordance with Japanese Industrial Standards (JIS) K7078 and interlaminar shear strength was measured. The term “interlaminar shear strength” means strength against the shear that shifts layers of a laminated plate, that is, a test piece in a parallel direction. The short beam method is an interlaminar shear test method using three-point bending of the test piece.

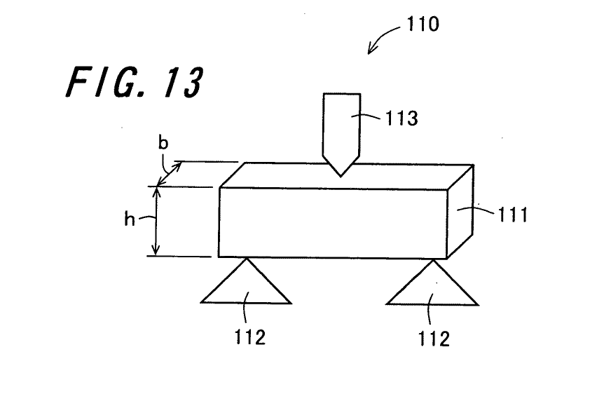

FIG. 13 is a schematic view illustrating an interlayer peeling test apparatus 110. As illustrated in FIG. 13, a test piece 111 is supported by two supports 112 and a load is applied using an indenter 113 to a center portion between two end portions of the test piece 111 in a longitudinal direction. A load-time diagram showing the relationship between the magnitude of a load and a loading time was measured. The test piece 111 was placed symmetrically on the support 112 so as to apply the load to the center portion of the test piece 111 by using the indenter 113. A test speed, that is, a loading speed was set at 1 mm (1 mm/min) per minute and a support-support distance, that is, a distance between supports 112 was set at 10 mm.

The magnitude of a load at the time when an interlaminar shear fracture occurred was determined from the load-time diagram thus measured and it was designated as a fracture force (Ps). An interlaminar shear strength (τ[MPa]) was determined from the fracture force (Ps[N]) based on the following equation (6). In the equation (6), the symbol [b] represents the width [mm] of the test piece 111 and the symbol [h] represents the thickness [mm] of the test piece 111. The measurement results are shown in Table 2.

$$\begin{matrix}[ Equation 5 ] & \\ τ = \frac{3 P s}{4 b h} & ( 6 )\end{matrix}$$

TABLE 2

| Reinforced | | Conductive | Interlaminar shear |
|---|---|---|---|
| fibers | Resin material | material | strength (MPa) |
| Opened | Example 6 | Carbon | 68.8 |
| | | nanocoil | |
| | Comparative | None | 66.7 |
| | Example 14 | | |
| Unopened | Example 7 | Carbon | 53.3 |
| | | nanocoil | |
| | Comparative | None | 48.3 |
| | Example 15 | | |

As shown in Table 2, the interlaminar shear strength is higher in the order of the resin material of Example 6 using, as the reinforced fibers thereof, opened fibers and containing a carbon nanocoil, the resin material of Comparative Example 14 using, as the reinforced fibers, opened fibers and containing no carbon nanocoil, the resin material of Example 7 using as the reinforced fibers thereof unopened fibers and containing a carbon nanocoil, and the resin material of Comparative Example 15 using as the reinforced fibers thereof unopened fibers and containing no carbon nanocoil, with the highest one last. Table 2 has revealed that use of opened fibers as the reinforced fibers enables an increase of interlaminar shear strength compared with the use of unopened fibers. In addition, it has been elucidated that as a result of comparison between the two resin materials using, as the reinforced fibers thereof, opened fibers or the two resin materials using unopened fibers, the resin material containing a carbon nanocoil has higher interlaminar shear strength than the resin material containing no carbon nanocoil. Superiority of the use of opened fibers and the use of a carbon nanocoil has been confirmed by the results of Table 2.

Thus, it has been elucidated that resin materials containing, in the matrix resin thereof, a carbon nanocoil have high strength and high vibration-damping property. In addition, results of Table 2 have revealed that in the case of fiber-reinforced composite resin materials containing reinforced fibers, addition of a carbon nanocoil to the matrix resin enables the preparation of a resin material having high vibration-damping property and at the same time, having high interlaminar shear strength and highly resistant to delamination, in other words, resin materials having high vibration-damping property and high delamination resistance.

The resin material of the invention and molded or formed product thereof have thus high strength and high vibration-damping property so that they are suited as materials for sporting goods or molded or formed products thereof (such as golf shaft and tennis racket), automobile materials or molded or formed products thereof (such as floor panel and toe board), aviation materials or molded or formed products thereof (such as aircraft wings), space materials or molded or formed products thereof, building structural materials or molded or formed products thereof, materials for transport equipment or molded or formed products thereof, materials for household electric appliances or molded or formed products thereof (such as washing machine and air conditioner), materials for industrial apparatuses or molded or formed products thereof (such as robot arm), coating compositions (such as coating compositions for reinforcing strength), covering materials (such as covering materials for reinforcing strength), and the like. In particular, aviation materials are required to have high strength and high vibration-damping property so that the resin material of the invention, and the molded or formed product and prepreg made of the resin material of the invention are especially suited as aviation materials, and molded or formed products thereof. For example, the resin material of the invention is suited as a material for aircraft wing; the prepreg made of the resin material of the invention is suited as a prepreg for aircraft wing; and the molded or formed product made of the resin material of the invention is suited as an aircraft wing or a portion thereof.

When the resin material of the invention is a fiber-reinforced composite resin material having reinforced fibers incorporated therein (which will hereinafter be called “composite resin material of the invention”), the composite resin material of the invention or molded or formed product thereof has high vibration-damping property and high delamination resistance so that they are especially suited as materials for sporting goods or molded or formed products thereof (such as golf shaft and tennis racket), automobile materials or molded or formed products thereof (such as floor panel and toe board), aviation materials or molded or formed products thereof (such as aircraft wings), space materials or molded or formed products thereof, building structural materials or molded or formed products thereof, materials for transport equipment or molded or formed products thereof, materials for household electric appliances or molded or formed products thereof (such as washing machine and air conditioner), materials for industrial apparatuses or molded or formed products thereof (such as robot arm), coating compositions (such as coating compositions for reinforcing strength), covering materials (such as covering materials for reinforcing strength), and the like. In particular, aviation materials are required to have high strength and high vibration-damping property so that the composite resin material of the invention and molded or formed product and prepreg made of the composite resin material of the invention are especially suited as aviation materials and molded or formed products thereof. For example, the composite resin material of the invention is especially suited as a material for aircraft wings; the prepreg made of the composite resin material of the invention is especially suited as a prepreg for aircraft wings; and the molded or formed product made of the composite resin material of the invention is especially suited as aircraft wings or a portion thereof.

The following are possible embodiments of the invention.

A vibration-damping material obtained by dispersing carbon nanocoils in a matrix resin.

In the invention (1), there is provided a vibration-damping material obtained by dispersing carbon nanocoils in a matrix resin. The carbon nanocoil has electrical conductivity, so that the carbon nanocoil easily converts a vibration energy generated in the vibration-damping material into heat and can damp the vibration energy in a short time. In addition, since the carbon nanocoil is in a coiled form, a contact area of the carbon nanocoils with the matrix resin is greater than that of conductive materials, such as carbon nanotube and graphite, other than the carbon nanocoil. By dispersing the carbon nanocoils in the matrix resin, it is therefore possible to convert a vibration energy generated in the vibration-damping material into heat in a shorter time and thereby damp the vibration energy in a shorter time compared with by dispersing conductive materials other than the carbon nanocoil in the matrix resin.

In addition, the carbon nanocoil is in the coiled form, so that different from the conductive materials other than the carbon nanocoil, the carbon nanocoil is deformable like a spring and it tends to restore the pre-deformation shape. Due to the restoring force, to the pre-deformation shape, of the carbon nanocoils dispersed in the matrix resin, the vibration-damping material can damp the vibration energy. When vibration is applied externally to the vibration-damping material, on the other hand, the carbon nanocoils dispersed in the matrix resin also vibrate. The carbon nanocoils convert this vibration energy received from the matrix resin into an expansion/contraction motion or shear motion of the carbon nanocoils themselves and thus consume the vibration energy, so that the carbon nanocoils can damp the vibration energy.

In the case of a composite material obtained by dispersing, in the matrix resin thereof, fillers having a micron size, for example, fillers having a particle size of 1 μm or greater and not greater than 100 μm, there is substantially a proportional relationship between the physical property of the composite material and a filling amount of the fillers. On the other hand, when fillers having a particle size within a submicron to nano range are used, surface effect thereof surpasses volume effect thereof due to an extreme increase in the surface area relative to the volume. In addition, the carbon nanocoil is in the nano-size coiled form, so that compared with conductive materials other than the carbon nanocoil, a contact area of the carbon nanocoils with the matrix resin is larger. The carbon nanocoils added in a smaller amount than conductive materials other than carbon nanocoil are therefore presumed to contribute to vibration-damping property.

Moreover, since the carbon nanocoil is in the coiled form, compared with use of conductive materials other than carbon nanocoil, in other words, conductive materials not in the coiled form, a contact area between carbon nanocoils contained in the matrix resin is smaller. The Van der Waals' force acting between carbon nanocoils is therefore smaller than Van der Waals' force acting between conductive materials other than carbon nanocoil so that the carbon nanocoil can be dispersed uniformly in the matrix resin. Thus, the carbon nanocoil can be dispersed uniformly in the matrix resin. By dispersing the carbon nanocoil in the matrix resin uniformly, the resulting vibration-damping material can have increased strength and sufficiently enhanced vibration-damping property.

A vibration-damping material having high strength and high vibration-damping property can therefore be obtained by dispersing the carbon nanocoils in the matrix resin.

(2) A vibration-damping material obtained by dispersing, in the matrix resin thereof, carbon nanocoils and reinforced fibers.

In the invention (2), there is provided a vibration-damping material obtained by dispersing, in the matrix resin thereof, carbon nanocoils and reinforced fibers. The vibration-damping material can have increased strength by the reinforced fibers dispersed in the matrix resin. In addition, the vibration-damping material can have high vibration-damping property by the carbon nanocoils dispersed in the matrix resin as described above. The vibration-damping material can therefore have improved vibration-damping property without reducing stiffness by dispersing the carbon nanocoils and reinforced fibers in the matrix resin. In addition, the carbon nanocoil serves as an anchor. By this anchor effect of the carbon nanocoil, interfacial separation between the matrix resin and reinforced fibers can be suppressed, whereby high strength, for example, high bending strength and high interlaminar shear strength can be achieved.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A vibration-damping resin material comprising a matrix resin and carbon nanocoils contained therein,
wherein the carbon nanocoil has an axial length of 0.5 μm or greater and not greater than 100 μm,
a coiled fiber constituting the carbon nanocoil has a diameter of 10 nm or greater but not greater than 500 nm,
a coil pitch of the carbon nanocoil is 10 nm or greater but not greater than 1500 nm, and
an external diameter of the carbon nanocoil is 50 nm or greater but not greater than 1000 nm.

2. The vibration-damping resin material of claim 1, wherein In the matrix resin contains reinforced fibers.

3. The vibration-damping resin material of claim 2, wherein a fiber diameter of the reinforced fibers is 3 μm or greater but not greater than 10 μm.

4. The vibration-damping resin material of claim 2 or 3, wherein a content of the reinforced fibers is 50% by volume or greater but not greater than 60% by volume based on a total volume of the vibration-damping resin material.

5. The vibration-damping resin material of any one of claims 1 to 4, wherein the matrix resin is at least one resin selected from epoxy resins, phenolic resins, unsaturated polyester resins, styrene resins, olefin resins, polyamide resins, and polycarbonate resins.

6. The vibration-damping resin material of any one of claims 1 to 4, wherein the matrix resin is an epoxy resin.

7. The vibration-damping resin material of any one of claims 2 to 4, wherein the reinforced fibers are opened carbon fibers.

8. A molded or formed product made of the vibration-damping resin material of any one of claims 1 to 7.

9. A vibration-damping curable resin composition comprising a matrix resin and carbon nanocoils,
wherein the carbon nanocoil has an axial length of 0.5 μm or greater and not greater than 100 μm,
a coiled fiber constituting the carbon nanocoil has a diameter of 10 nm or greater but not greater than 500 nm,
a coil pitch of the carbon nanocoil is 10 nm or greater but not greater than 1500 nm, and
an external diameter of the carbon nanocoil is 50 nm or greater but not greater than 1000 nm.

10. The vibration-damping curable resin composition of claim 9, wherein the matrix resin contains reinforced fibers.

11. The vibration-damping curable resin composition of claim 10, wherein a fiber diameter of the reinforced fibers is 3 μm or greater but not greater than 10 μm.

12. The vibration-damping curable resin composition of claim 10 or 11, wherein a content of the reinforced fibers is 50% by volume or greater but not greater than 60% by volume based on the total volume of the vibration-damping curable resin composition.

13. A molded or formed product obtained by curing the vibration-damping curable resin composition of any one of claims 9 to 12.

14. A prepreg made by impregnating fibers with the vibration-damping curable resin composition of any one of claims 9 to 12 and applying pressure while heating.
